(19) United States
(12) Patent Application Publication
(10) Pub. No.: US 2010/0102627 A1
(43) Pub. Date: Apr. 29, 2010

(54) Power Supply Device And Electric Vehicle Incorporating Said Device

(75) Inventor: Hiroshi ABE, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/604,531

(22) Filed: Oct. 23, 2009

(30) Foreign Application Priority Data
Oct. 24, 2008 (JP) 2008-274670

(51) Int. Cl. B60L 1/00; H02J 1/10

(52) U.S. Cl. 307/9.1; 307/43

(57) ABSTRACT

To provide a power supply device and an electric vehicle using the power supply device that can warm up each of a plurality of power storage devices while restraining occurrence of variation in the temperatures of the plurality of power storage devices, a control unit performs a warm-up control that increases a time ratio of the ON state of a switch element relating to one of the plurality of power storage devices in controlling the ratio of ON and OFF states of the switch element as compared to a time ratio of the ON state of a switch element relating to other power storage device when a temperature detected at the temperature detection unit relating to the one of the plurality of power storage devices is lower than a first temperature.

### CROSS REFERENCE TO RELATED APPLICATIONS

This application claims priority under 35 USC 119 from prior Japanese Patent Application No. P2008-274670 filed on Oct. 24, 2008, the entire contents of which are incorporated herein by reference.

### BACKGROUND OF THE INVENTION

1. Field of the Invention

The present invention relates to a power supply device having a plurality of power storage devices connected in parallel. The present invention also relates to an electric vehicle that incorporates such a power supply device.

2. Description of Related Art

A power supply device having a plurality of power storage devices connected in parallel is generally known for achieving high energy storage capacity and high power output. Such a power supply device is used for example in an electric vehicle.

Generally, output characteristics of each power storage device depend on a temperature of each power storage device, and the output characteristics of each power storage device tend to descend as the temperature of each power storage device becomes lower.

Thus, a power supply device was proposed in which a load for warming-up is provided, which can switch its electrical connection with one of a plurality of power storage devices (see Japanese Patent Laid-Open No. 2003-32901). When warming-up a power storage device, after energy is discharged from the power storage device to the load for warming up, the plurality of power storage devices are electrically connected with each other thereby charging the power storage device which was discharged. With this, the power storage device can be warmed-up utilizing its self-heating due to its internal resistance.

However, in the above-described power supply device, the plurality of power storage devices cannot be selectively warmed-up. Therefore, there exists a problem in that variation occurs in the temperatures of the plurality of power storage devices. The degree of deterioration varies among the power storage devices due to the variation of the temperatures of the plurality of power storage devices, which causes the operating life duration of the power supply device to be reduced.

Therefore, an object of the invention is to solve the above-described problems and to provide a power supply device and an electric vehicle incorporating the power supply device, which can warm-up each of the plurality of power storage devices while reducing variation in the temperatures of the plurality of power storage devices.

### SUMMARY OF THE INVENTION

One aspect of the invention relates to a power supply device having a plurality of power storage devices connected to a load, which includes temperature detection units for respectively detecting temperatures of the plurality of power storage devices; switch elements respectively connected in series with the plurality of power storage devices respectively between the plurality of power storage devices and the load; and a control unit for controlling the ON and OFF states of the switch elements, in which the plurality of power storage devices are connected in parallel with each other, and in which when a temperature detected at the temperature detection unit relating to one of the plurality of power storage devices is lower than a first temperature, the control unit performs a warm-up control that increases a time ratio of the ON state of a switch element relating to the one of the plurality of power storage devices in controlling the ratio of ON and OFF states of the switch element as compared to a time ratio of the ON state of a switch element relating to other power storage device in controlling the ratio of ON and OFF states of the switch element.

In the power supply device according to the features of the invention, the first temperature may be a temperature at which respective maximum outputs of the plurality of power storage devices fall below respective rated outputs.

The power supply device according to the features of the invention may include an air agitator for agitating air in a space in which the plurality of power storage devices are installed, and the control unit operates the air agitator if temperatures detected at the temperature detection units are respectively higher than a second temperature, in which the second temperature may be higher than the first temperature.

In the power supply device according to the features of the invention, the one power storage device may be a power storage device having the lowest temperature detected at the temperature detection unit.

In the power supply device according to the features of the invention, the one power storage device may be a power storage device having the highest temperature among the power storage devices having temperatures detected at the temperature detection units that are lower than the first temperature.

Another aspect of the invention relates to an electric vehicle, which includes the above-described power supply device, an electric motor that produces mechanical power from electric power supplied by the power supply device, and a drive wheel to which the power generated by the electric motor is transmitted.

### BRIEF DESCRIPTION OF THE DRAWINGS

FIG. 1 is a circuit diagram of a power supply device according to an embodiment of the present invention.

FIG. 2 is a chart showing a relationship between a temperature of the power storage device and a maximum output of the power storage device.

FIG. 3 is a flowchart showing operations of a starting control of a control unit 50 of FIG. 1.

FIG. 4 is a flowchart showing operations of a warm-up control of the control unit 50 of FIG. 1.

FIG. 5 is a flowchart showing operations of an air agitating control of the control unit 50 of FIG. 1.

FIG. 6 is a block diagram of an electric vehicle incorporating the power supply device of FIG. 1, in accordance with another aspect of the invention.

### DETAILED DESCRIPTION OF THE INVENTION

Specific embodiments of the power supply device according to the present invention will be described hereinafter by referring to the drawings. In each of the drawings to be referred to, the same or similar reference numbers are assigned to the same or similar parts.

However, the drawings are provided for explanation only and it should be noted that details such as the ratios of each dimension may differ from reality. Therefore, specific dimensions etc. should be determined by referring to the description below. It also should be noted that there may be parts the dimensional relationships and ratios of which may differ among the drawings.

### First Embodiment

### Structure of the Power Supply Device

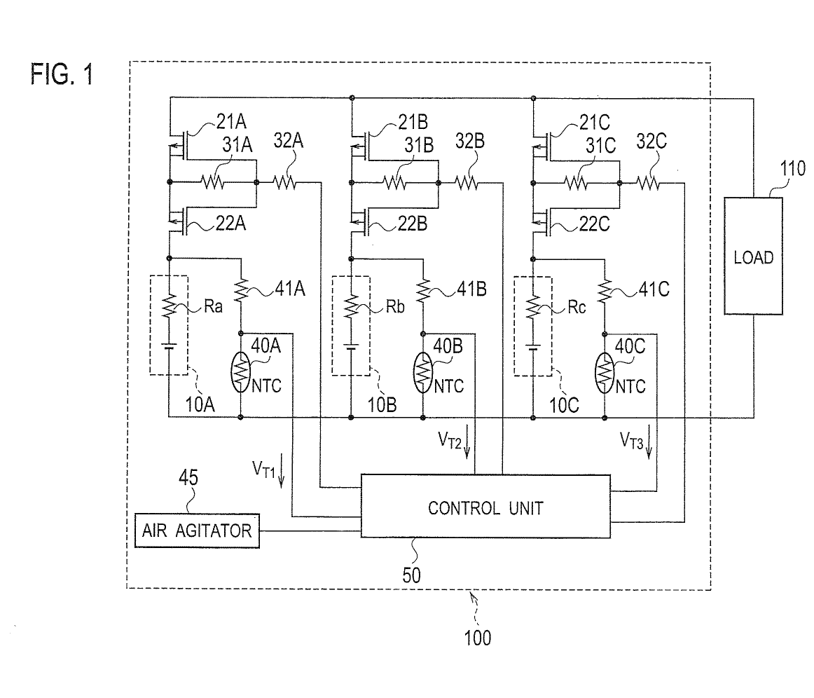

The first embodiment of the power supply device according to the invention now will be described by referring to the drawings below. FIG. 1 is a circuit diagram showing a power supply device 100 according to the first embodiment.

As shown in FIG. 1, the power supply device 100 has a plurality of power storage devices (power storage devices 10A to 10C), a plurality of switch elements (Field-Effect Transistors (FETs) 21A/22A to 21C/22C), a first plurality of resistors (resistors 31A/32A to 31C/32C), a plurality of temperature detection units (NTCs 40A to 40C), a second plurality of resistors (resistors 41A to 41C), an air agitator 45, and a control unit 50.

The power storage devices 10A to 10C are connected in parallel with each other and a load 110 is electrically connected to the power storage devices 10A to 10C respectively. The power storage devices 10A to 100 respectively have internal resistances Ra to Rc. For example, in a case in which the power supply device 100 is used in an electric vehicle (EV; Electric Vehicle, HEV; Hybrid Electric Vehicle), the load 110 is for example an electric motor provided in the electric vehicle.

Here, it should be noted that the circuits of the power storage devices 10A to 10C respectively have similar structures.

The power storage devices 10A to 10C are devices that store electric charge. Positive electrodes of the power storage devices 10A to 100 are connected to drains of the FETs 22A to 22C. Negative electrodes of the power storage devices 10A to 10C are connected to the load 110.

The FETs 21A/22A to 21C/22C are field effect transistors each having a gate, a source, and a drain. The FETs 21A/22A to 21C/22C are connected to the power storage devices 10A to 10C in series, and respectively switch the connection conditions between the power storage devices 10A to 10C and the load 110. The power storage devices 10A to 100 are electrically connected to the load 110 through the FETs 21A/22A to 21C/22C. If the FETs 21A/22A to 21C/22C are in the ON state, the power storage devices 10A to 10C are connected to the load 110, and if the FETs 21A/22A to 21C/22C are in the OFF state, the power storage devices 10A to 10C are disconnected or separated from the load 110. The gates of the FETs 21A/22A to 21C/22C are connected to the control unit 50 through the resistors 32A to 32C. The drains of the FETs 21A to 21C are connected to the load 110 and the sources of the FETs 21A to 21C are connected to the sources of the FETs 22A to 22C and one end of respective resistors 31A to 31C. The drains of the FETs 22A to 22C are connected to the positive electrodes of the power storage devices 10A to 10C, and the sources of the FETs 22A to 22C are connected to the sources of the FETs 21A to 21C and one end of respective resistors 31A to 31C.

The NTCs 40A to 40C are thermistors that detect temperatures of the power storage devices 10A to 10C. Here, as an example of a thermistor, a NTC (Negative Temperature Coefficient) thermistor is used. However, a PTC (Positive Temperature Coefficient) thermistor also may be used.

As the temperatures of the NTCs 40A to 40C increase, resistance values of the NTCs 40A to 40C decrease. In addition, the NTCs 40A to 40C are provided in the vicinities of the power storage devices 10A to 10C respectively. In other words, the temperatures of the NTCs 40A to 40C are correlated to the temperatures T1 to T3 of the power storage devices 10A to 10C.

The NTCs 40A to 40C are connected to the drains of the FETs 22A to 22C through the resistors 41A to 410, and are connected in parallel with the power storage devices 10A to 10C. The resistances values of the NTCs 40A to 40C are obtained from voltages V_{T1} to V_{T3} applied to the NTCs 40A to 40C, and the temperatures of the NTCs 40A to 40C (that is, the temperatures T1 to T3 of the power storage devices 10A to 10C) are obtained from the resistance values of the NTCs 40A to 40C.

The air agitator 45 operates either under an agitation mode in which the agitator 45 agitates the air in a space where the power storage devices 10A to 10C are installed or under a cooling mode in which the agitator 45 cools the power storage devices 10A to 10C by blowing air to the power storage devices 10A to 10C. Operation conditions of the air agitator 45 will be described below in more detail. The air agitator 45 for example is a fan or a valve of a natural air-cooling device for taking in the external air. If the air agitator 45 is a fan, the agitation mode and the cooling mode may be switched according to the speed of revolution. If the air agitator 45 is a valve, the agitation mode and the cooling mode may be switched according to a degree of opening of the valve.

The control unit 50 controls the ON state and the OFF state of the switch elements (FETs 21A/22A to 21C/22C). In the first embodiment, at the time of starting the power storage devices 10A to 10C, if one of the temperatures T1 to T3 of the power storage devices 10A to 10C is lower than a first temperature TF, the control unit 50 performs a warm-up control that increases a time ratio of the ON state of the switch element relating to the power storage device whose temperature is lower than the first temperature TF as compared to time ratios of the ON state of the switch elements relating to the other power storage devices.

In particular, the control unit 50 measures the temperatures T1 to T3 of the power storage devices 10A to 10C from the voltages V_{T1} to V_{T3} applied to the NTCs 40A to 40C. Next, if at least one of the temperatures T1 to T3 of the power storage devices 10A to 10C is lower than the first temperature TF, the control unit 50 performs a duty ratio control to increase the duty ratio of the switch element relating to the power storage device 10 having the lowest temperature among the power storage devices 10A to 10C as compared to the duty ratios of the switch elements relating to the other power storage devices. The duty ratio is a ratio of time that the switch element is in the ON state per unit time, that is, the amount of unit time that each of the power storage devices 10A to 10C is connected to the load 110 (e.g., a duty ratio of 70 means that the switch element is in the ON state for 70% of the unit time).

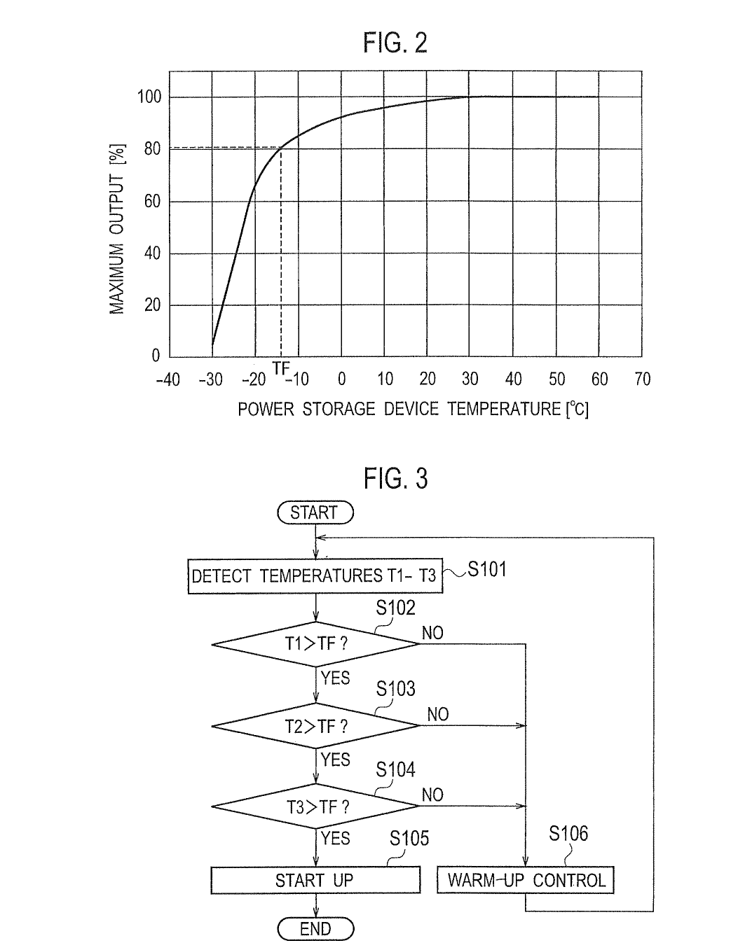

The first temperature TF is a temperature at which maximum outputs of the power storage devices 10A to 10C fall below the rated outputs of the power storage devices 10A to 10C. As shown in FIG. 2, the maximum output of the power storage device usually decreases rapidly when the temperature of the power storage device is decreased below a certain threshold temperature. Therefore, as shown in FIG. 2, the temperature at which the maximum output of the power storage device becomes 80% of the rated output of the power storage device can be set as the first temperature TF.

Moreover, when performing a warm-up control, if each of the temperatures T1 to T3 of the power storage devices 10A to 10C becomes higher than a second temperature TS, the control unit 50 operates the air agitator 45 in the agitation mode. The second temperature TS is a temperature at which the maximum output of the power storage device falls below the rated output of the power storage device, and is a temperature that is higher than the first temperature TF. In addition, when the power supply device 100 is started, the control unit 50 switches the air agitator 45 from the agitation mode to the cooling mode.

(Operations of the Power Supply Device)

Operations of the power supply device concerning the first embodiment will be now described by referring to the drawings below.

FIG. 3 is a flowchart showing operations of a starting control of the power supply device 100 (the control unit 50) according to the first embodiment. In the starting control, the control unit 50 determines whether or not it is possible to start supplying electric power from the power storage devices 10A to 10C to the load 110.

At step S101, the control unit 50 detects the temperatures T1 to T3 of the power storage devices 10A to 10C.

At step S102 to step S104, the control unit 50 determines whether or not each of the temperatures T1 to T3 is higher than the first temperature TF. If all of the temperatures T1 to T3 are higher than the first temperature TF, the process advances to step S105. If any of the temperatures T1 to T3 is lower than the first temperature TF, the process advances to step S106.

At step S105, the control unit 50 starts the power supply device 100 in response to a determination that the electric power supply can be sufficiently started from the power storage devices 10A to 10C to the load 110.

At step S106, the control unit 50 starts the warm-up control, which will be described below, in response to a determination that the electric power supply cannot be sufficiently started from the power storage devices 10A to 10C to the load 110. Thereafter, once the warm-up control is completed, the process returns to step S101.

At the time when the process returns from step S106 to step S101, the process also may include a waiting step for a predetermined wait time. Such a predetermined wait time is set up according to the tendencies of temperature change of the power storage devices 10A to 10C and the power supply device 100. For example, if the tendency of temperature change is small, it is preferable to set the predetermined wait time to be longer.

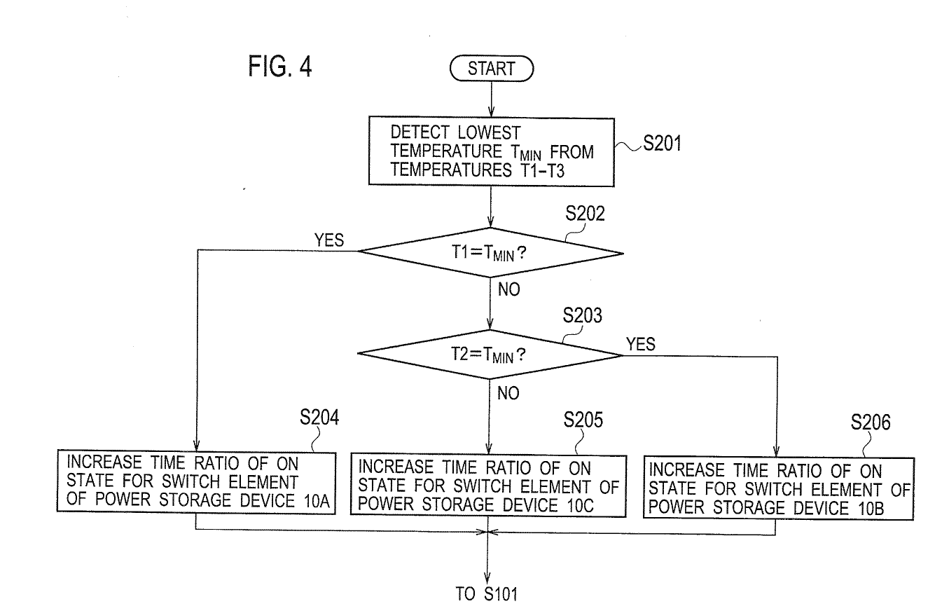

FIG. 4 is a flowchart showing operations of the warm-up control of the power supply device 100 (the control unit 50) according to the first embodiment.

At step S201, the control unit 50 detects the lowest temperature ZEN among the temperatures T1 to T3.

At step S202, the control unit 50 determines whether or not the temperature T1 is the lowest temperature T_{MIN}. If the temperature T1 is not the lowest temperature T_{MIN}, the process advances to step S203. If the temperature T1 is the lowest temperature T_{MIN}, the process advances to step S204.

At step S203, the control unit 50 determines whether or not the temperature T2 is the lowest temperature T_{MIN}. If the temperature T2 is not the lowest temperature T_{MIN}, the process advances to step S205. If the temperature T2 is the lowest temperature T_{MIN}, the process advances to step S206.

At step S204, the control unit 50 increases a time ratio of the ON state of the switch elements 21A/22A of the power storage device 10A compared with time ratios of the ON state of the switch elements 21B/22B of the power storage device 10B and the switch elements 21C/22C of the power storage device 10C.

At step S205, the control unit 50 increases a time ratio of the ON state of the switch elements 21C/22C of the power storage device 10C compared with time ratios of the ON state of the switch elements 21A/22A of the power storage device 10A and the switch elements 21B/22B of the power storage device 10B.

At step S206, the control unit 50 increases a time ratio of the ON state of the switch elements 21B/22B of the power storage device 10B compared with time ratios of the ON state of the switch elements 21A/22A of the power storage device 10A and the switch elements 21C/22C of the power storage device 10C.

After the steps S204 to S206, the process returns to step S101. As described above, the control unit 50 performs the warm-up control of the power storage device 10 in ascending order of the temperatures, and therefore, at the time when temperatures of all the power storage devices 10A to 10C have become equal to or more than the first temperature TF, temperature variation among the power storage devices 10A to 10C is eliminated. The control unit 50 performs the warm-up control repeatedly until the all the temperatures of the power storage devices 10A to 10C have reached a temperature above the first temperature TF.

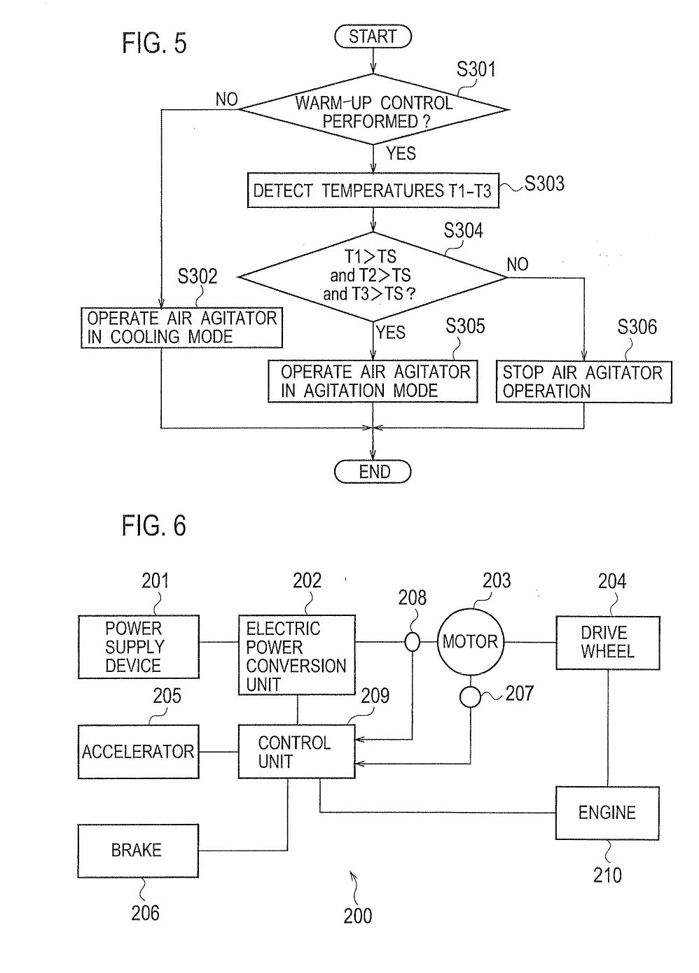

FIG. 5 is a flowchart showing operations of an air agitating control of the power supply device 100 (the control unit 50) according to the first embodiment.

At step S301, the control unit 50 determines whether or not the warm-up control is being performed. If the warm-up control is not being performed, the process advances to step S302. If the warm-up control is being performed, the process advances to step S303.

At step S302, the control unit 50 operates the air agitator 45 in the cooling mode.

At step S303, the control unit 50 detects the temperatures T1 to T3 of the power storage devices 10A to 10C.

At step S304, the control unit 50 determines whether or not the temperatures T1 to T3 of the power storage devices 10A to 10C respectively are higher than the second temperature TS. If all of the temperatures T1 to T3 are higher than the second temperature TS, the process advances to step S305. If any of the temperatures T1 to T3 is lower than the second temperature TS, the process advances to step S306.

At step S305, the control unit 50 operates the air agitator 45 in the agitation mode.

At step S306, the control unit 50 maintains the operation of the air agitator 45 to remain stopped.

(Operations and Effects)

When any of the temperatures T1 to T3 of the power storage devices 10A to 10C is equal to or lower than the first temperature TF, the control unit 50 performs the warm-up control which increases a time ratio of the ON state of the switch element relating the power storage device 10 whose temperature is lower than the first temperature TF as compared to time ratios of the ON state of the switch elements of the other power storage devices.

Therefore, the control unit 50 can perform the warm-up control individually for each of the power storage devices 10A to 10C. Accordingly, the occurrence of temperature variation among the power storage devices 10A to 10C can be restrained. As a result, the degree of deterioration of each of the power storage devices 10A to 10C can be reduced and thus the operating life duration of the power supply device can be extended.

Also, the control unit 50 operates the air agitator 45 in the agitation mode when all of the temperatures T1 to T3 of the power storage devices 10A to 10C are higher than the second temperature TS. The second temperature TS is a temperature that is higher than the first temperature TF. Therefore, at the time when the variation among the temperatures T1 to T3 becomes small, the air is agitated. Thus, fine variation among the temperatures T1 to T3 of the power storage devices 10A to 10C can be eliminated effectively.

Also, the control unit 50 selects a power storage device 10 having the lowest temperature as the one power storage device 10 on which the warm-up control is performed. Therefore, temperature variation among the power storage devices 10A to 10C can be promptly reduced.

### Second Embodiment

Now the second embodiment of the invention will be described. In the second embodiment, an electric vehicle (HEV; Hybrid Electric Vehicle) in which the above-described power supply device 100 is provided will be described.

(Structure of the Electric Vehicle)

Now the electric vehicle according to the second embodiment will be described by referring to the drawings below. FIG. 6 is a view showing an electric vehicle 200 according to the second embodiment.

As shown in FIG. 6, the electric vehicle 200 includes a power supply device 201, a power conversion unit 202, a motor 203, a drive wheel 204, an accelerator 205, a brake 206, a rotation sensor 207, a current sensor 208, a control unit 209, and an engine 210.

The power supply device 201 is the power supply device 100 as described above. That is, the power supply device 201 includes the power storage devices 10 that are connected in parallel.

The power conversion unit 202 converts the electric power from the power supply device 201 to electric power required by the motor 203 according to an operation of the motor 203. Also, in a case that the motor 203 performs regeneration, the power conversion unit 202 converts the electric power from the motor 203 to electric power to be stored in the power supply device 201 according to an operation of the motor 203.

The motor 203 generates torque by the electric power converted by the power conversion unit 202. The torque generated by the motor 203 is transmitted to the drive wheel 204.

The drive wheel 204 is a wheel connected to the motor 203 among the wheels provided in the electric vehicle 200.

The accelerator 205 is a mechanism to increase the rotation speed of the motor 203 or the engine 210. The brake 206 is a mechanism to decrease the rotation speed of the motor 203 or the engine 210.

The rotation sensor 207 detects the rotation speed of the motor 203. The current sensor 208 detects the current value supplied to the motor 203.

The control unit 209 computes command torque based on the information obtained from the accelerator 205 and the rotation sensor 207 etc. The control unit 209 computes a current command value based on the command torque. The control unit 209 controls the power conversion unit 202 based on the difference between the current value obtained from the current sensor 208 and the current command value. With this, the control unit 209 controls the rotation speed of the motor 203. In addition, the control unit 209 controls power regeneration of the motor 203 based on information obtained from the brake 206 etc.

The engine 210 generates torque by combustion of fuel. The torque generated by the engine 210 is transmitted to the drive wheel 204. Here, when the drive wheel 204 is driven using the engine 210 or when the electric vehicle 200 is stopped, the motor 203 is stopped. In this case, the motor 203 can be utilized as a resistance load for the warm-up control. For example, if the motor 203 is a three-phase motor, the motor 203 does not rotate by flowing a current only through a first phase. Therefore, the motor 203 can be utilized as the resistance load of the warm-up control by flowing a current only through the first phase.

As such, it should be noted that the control unit 50 can perform the warm-up control regardless of the operation state of the electric vehicle 200.

### Other Embodiments

While the thermistor was illustrated as the temperature detection unit in the above-described embodiments, the temperature detection unit is not limited to the thermistor.

While the FET was illustrated as the switch element in the above-described embodiments, the switch element is not limited to the FET. For example, the switch element also may be a bipolar transistor.

In the above-described embodiments, the circuit structure of the power supply device 100 was only illustrative, and the circuit structure of the power supply device 100 may be modified accordingly.

In the above-described embodiments, the power supply device 100 performed the warm-up control in ascending order from the lowest temperature. However the order of the warm-up control may be in descending order from the highest temperature. In this case, the warm-up control is performed with respect to a power storage device having the highest temperature among the power storage devices having temperatures that are lower than the first temperature TF. As such, the temperature of the power storage device for which the warm-up control is needed is aligned to the first temperature TF. Moreover, in this case, it is preferable to agitate the air with the air agitator. With this, a power storage device with a significantly low warm-up efficiency due to the excessively low temperature can be warmed up by the heat generated at the power storage devices on which the warm-up control was performed. As a result, the warm-up control can be reliably performed with respect to all the power storage devices.

In the above-described embodiments, such as the motor of the electric vehicle was utilized as the load 110. However, the load 110 may be a load that is used exclusively for the warm-up control.

In the above-described embodiments, the power supply device 100 performed the air agitating control. However, the power supply device 100 does not have to perform the air agitating control.

In the above-described embodiments, the power supply device 100 included three power storage devices 10A to 10C that are connected in parallel with each other. However, the power supply device 100 may include two, four, or more than four power storage devices 10 that are connected in parallel with each other.

Although not specifically mentioned in the above-described embodiments, each power storage device 10A to 10C may include a plurality of power storage devices connected in series. With this, high output power of the power supply device 210 can be achieved.

According to the invention, it is possible to provide a power supply device and an electric vehicle that can individually warm up each of the plurality of power storage devices while restraining occurrence of temperature variation of the plurality of power storage devices.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes that come within the meaning and range of equivalency of the claims therefore are intended to be embraced therein.

What is claimed is:

1. A power supply device having a plurality of power storage devices connectable to a load, comprising:
a plurality of temperature detection units for respectively detecting temperatures of the plurality of power storage devices;
a plurality of switch elements respectively connected in series with the plurality of power storage devices between the plurality of power storage devices and the load; and
a control unit for controlling the ON and OFF states of the switch elements,
wherein the plurality of power storage devices are connected in parallel with each other, and
wherein when a temperature detected at the temperature detection unit relating to at least one of the plurality of power storage devices is lower than a first temperature, the control unit performs a warm-up control that increases a time ratio of the ON state of a switch element relating to the one of the plurality of power storage devices in controlling the ratio of ON and OFF states of the switch element as compared to a time ratio of the ON state of a switch element relating to other power storage device in controlling the ratio of ON and OFF states of the switch element.

2. The power supply device of claim 1,
wherein the first temperature is a temperature at which respective maximum outputs of the plurality of power storage devices fall below a predetermined percentage of respective rated outputs.

3. The power supply device of claim 1, further including an air agitator for agitating air in a space in which the plurality of power storage devices are installed,
wherein the control unit operates the air agitator if temperatures detected at the temperature detection units are respectively higher than a second temperature, and
wherein the second temperature is higher than the first temperature.

4. The power supply device of claim 1, wherein the one of the plurality of power storage devices is a power storage device having the lowest temperature detected at the temperature detection unit among said plurality of power storage devices.

5. The power supply device of claim 1, wherein the one of the plurality of power storage devices is a power storage device having the highest temperature among said plurality of power storage devices having temperatures detected at the temperature detection units that are lower than the first temperature.

6. An electric vehicle, comprising:
the power supply device of claim 1;
an electric motor for generating power from electric power supplied by the power supply device; and
a drive wheel to which the power generated by the electric motor is transmitted.
